(19) United States
(12) Patent Application Publication
(10) Pub. No.: US 2014/0125795 A1
(43) Pub. Date: May 8, 2014

(54) Trailer Coupling Assistant

(71) Applicant: James Arnold Yerke, New Lisbon, WI (US)

(72) Inventor: James Arnold Yerke, New Lisbon, WI (US)

(21) Appl. No.: 14/064,252

(22) Filed: Oct. 28, 2013

Related U.S. Application Data
(60) Provisional application No. 61/722,302, filed on Nov. 5, 2012.

(51) Int. Cl. B60R 1/00

(52) U.S. Cl. CPC B60R 1/003
USPC 348/118

(57) ABSTRACT

A trailer hitch alignment and coupling assistant is provided that is adapted to provide the driver of a towing vehicle with a clear indication of the relative positioning of the vehicle trailer hitch ball mount and the trailer coupler when maneuvering the towing vehicle. The system comprises a rear-mounted, downward facing imaging means and light source, which is adapted to capture the position of a first and second marker placed on the ball mount and trailer coupler, respectively. The image is communicated to a display unit within the vehicle cab for the operator to see the relative positioning of the two markers while reversing the vehicle. The markers are preferably reflective and visible in low light conditions. The rear-mounted image means comprises an operably mountable, wireless device, or alternately a hardwired device along the vehicle rear. Similarly, the display unit is a mountable fixture or hardwired into the vehicle cab.

### CROSS REFERENCE TO RELATED APPLICATION

This application claims the benefit of U.S. Provisional Application No. 61/722,302 filed on Nov. 5, 2012, entitled “Backup Beacon.” The above identified patent application is herein incorporated by reference in its entirety to provide continuity of disclosure.

### BACKGROUND OF THE INVENTION

1. Field of the Invention

The present invention relates to tow hitches and connecting a lead vehicle to a trailer via a trailer hitch attachment means. More specifically, the present invention pertains to a driver aid that provides a driver of the lead vehicle with a clear image of the trailer hitch area and clear markers on the trailer hitch ball mount and the trailer coupler such that the driver can align the two without assistance from another individual.

There are many scenarios in which attachment of a trailer to a lead vehicle is necessary, both commercially and individually. The most common trailer attachment is the trailer hitch and extended ball mount, wherein a receiver tube within the trailer hitch supports an extended ball joint adapted to make connection with a ball mount coupler along the trailer leading end. The ball joint, once connected, serves as a support for the weight of the trailer at its leading end, and further connects the forward and rearward motion of the lead vehicle to the trailer so that transport is possible. The ball joint also allows for relative movement of the trailer and trailer hitch during use, making this connect a robust means of securing a trailer to a lead vehicle.

The procedure for connecting a ball mount to a trailer coupler can be quite difficult for the untrained, and even present problems for the most seasoned of vehicle operators. First, the trailer is fixed in position and the coupler is supported by a tongue jack such that the coupler remains in place. Then, the vehicle is reversed toward the coupler such that the ball mount is aligned with the coupler. Generally, the vehicle operator will require assistance from a bystander to properly co-locate the ball mount and coupler, or alternatively the vehicle operator has to depart from the vehicle to periodically check for proximity and alignment.

Properly aligning the ball mount with the coupler is essential for making connection and for enabling the coupler locking mechanism to secure to the ball mount. For smaller trailers without cargo, a user can simply move the lead vehicle within a few feet of the coupler, whereafter the user can lift the coupler and manually move the entire trailer into position. For larger trailers and for those loaded with cargo, this is a more difficult task, and one that may not be possible via manual input. Therefore, accurate alignment and placement of the ball mount is essential in many applications.

Improperly locating a ball mount not only limits the ability of the operator to couple the trailer to the vehicle, it also exposes the trailer to the risk of damage from the lead vehicle and its ball mount. Without the ability to locate the coupler or the trailer, an operator may reverse into the trailer or puncture the same with the extended coupler. Locating the relative position of the coupler and ball mount, and lead vehicle and trailer is essential to achieve connection and to prevent damage to each of the vehicles during this process.

The present invention pertains to a new and novel trailer attachment locating system that is adapted to assist the vehicle operator when reversing the lead vehicle toward the trailer coupler. It is desired to provide an imaging system with readily identifiable markers on the coupler and the ball mount such that their relative positioning can be visualized from within the vehicle cabin, and therefore bystander support is not required. Specifically, a downward, rear-facing camera is provided that communicates to a cabin-mounted screen, whereby markers on the coupler and the ball mount are provided such that the two can be co-located from an overhead perspective. This allows the operator to easily align the two assemblies, and thereafter depart the vehicle to lower the coupler onto the ball mount once the two are positioned in vertical alignment.

2. Description of the Prior Art

Devices have been disclosed in the prior art that relate to trailers and means of attaching the same to a lead vehicle. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

U.S. Pat. No. 4,187,494 to Jessee discloses a vehicle guidance device that facilitates positioning of a towing vehicle with respect to a lead vehicle using a physical connection between the two and a means of measuring alignment deviations. A flexible tension member is connected between the vehicles while a sensing device indicates to the operator based on the tension member where the vehicle should be maneuvered to position the hitch components. Left and right directional signals are generated for the operator of the vehicle based on the sensing device and the positioning of the tension member between vehicles. While providing a means to guide the two vehicles together, the Jessee device requires a physical connection. The present invention pertains to a visual means of locating the hitch components, whereby the operator can visualize the hitch coupler and the ball mount from an overhead perspective.

U.S. Pat. No. 5,309,289 to Johnson discloses a visual means of aligning hitch components between a lead vehicle and a trailer, whereby a viewing mirror is removably positionable on the towed vehicle. The mirror provides the operator with a visual reference when attaching the ball mount to the coupler, which support two targets that improve their clarity of each component and highlight their relative positioning. The Johnson device, while providing visual reference for the operator, utilizes a mirror and target system that requires attachment of the mirror on the trailer. The present invention utilizes an attachable, downward facing camera that communicates to an internal display that does not require the operator to look through multiple mirrors. The present invention provides a direct, overhead view of the hitch components as the two are moved into position.

U.S. Patent Publication No. 2008/0180526 to Trevino discloses a device for assisting an operator backing a towing vehicle towards a trailer, wherein a camera and beam of light are utilized to guide the operator into the correct position relative to the hitch components. The beam of light is utilized in conjunction with a target mounted on the trailer coupler, whereby the operator can view the alignment of the hitch components through the camera by way of the light reflecting from a reticle on the target. This assembly requires the mounting of a camera, light beam, and target on the hitch components, wherein the user can monitor the placement of the ball mount from the perspective of the trailer coupler while in reverse. The present invention contemplates a simpler system that employs a downward facing camera to give a planar, overhead view of the coupler and the ball hitch as they approach one another. Markers on each hitch component can be added such that the two are readily recognizable in different light levels, while the initial height positioning of each hitch component is set before the operator begins to align the components.

U.S. Pat. No. 7,777,615 to Okuda discloses a system for assisting an operator in aligning trailer hitch components, whereby a camera mounted on the lead vehicle displays the position of the hitch components and a processor calculates the preferred path to achieve a connection thereof. The pathway is shown on the screen for the operator while audible signals are generated to provide instructions for turning the vehicle. The Okuda device, while utilizing a rear camera and in-vehicle display, does not contemplate targets on the hitch components that would assist in low light conditions.

The present invention provides a trailer coupling system that is readily deployable on existing vehicles, or easily incorporated into new towing vehicles. The system includes a rear-mounted imaging means and light source that is adapted to capture the relative positioning of the towing vehicle ball mount and the trailer coupler. The relative positioning is useful to the vehicle operator when reversing the vehicle towards the trailer coupler in order to make connection therewith. For heavier trailers, near-exact placement of the ball mount below the coupler may be required, therefore the present system contemplates a means of achieving this end without outside assistance or the operator leaving the cab to periodically check the relative location of the hitch components.

The relative positioning of markers placed on the coupler and ball mount are picked up by the imaging system and overlaid onto a two dimensional plot for the operator to register their relative positioning. The operator can then reverse and orient the vehicle such that the two markers on the in-vehicle display or overlaid over one another. The height of the coupler and ball mount are first adjusted to prevent interferences, and once the markers are overlaid the operator knows the hitch components can make connection with further movement of the vehicle or trailer.

It is submitted that the present invention is substantially divergent in design elements from the prior art, and consequently it is clear that there is a need in the art for an improvement to existing trailer hitch coupling system devices. In this regard the instant invention substantially fulfills these needs.

### SUMMARY OF THE INVENTION

In view of the foregoing disadvantages inherent in the known types of trailer hitch alignment and coupling assistants now present in the prior art, the present invention provides a new system that can be utilized for providing convenience for the user when aligning the ball mount of a towing vehicle with a trailer coupler without outside assistance.

It is therefore an object of the present invention to provide a new and improved trailer hitch alignment system that has all of the advantages of the prior art and none of the disadvantages.

It is another object of the present invention to provide a trailer hitch alignment system that includes a rear-mounted imaging means and a first and second marker to plot the position of the trailer hitch ball mount and the trailer coupler for the vehicle operator to align the hitch components of the towing vehicle and trailer.

Another object of the present invention is to provide a trailer hitch alignment system that utilizes a first and second reflective marker and an algorithm for plotting the position of the trailer coupler and trailer hitch ball mount on a two dimensional plot for the user to visualize in a display within the vehicle cab.

Yet another object of the present invention is to provide a trailer hitch alignment system that includes readily deployable system elements for an existing vehicle and trailer.

Another object of the present invention is to provide a trailer hitch alignment system that can be integrated into a new vehicle that is adapted to be provided as an accessory or original equipment from a vehicle manufacturer.

Another object of the present invention is to provide a trailer hitch alignment system that uses a simple marker system that can be adapted for use on any trailer coupler and ball mount, and thereafter removed for later use with different trailers.

Another object of the present invention is to provide a trailer hitch alignment system that simplifies the trailer hitch ball mount and coupler position to a two dimensional marker plot, wherein their relative positions can be monitored while maneuvering the towing vehicle.

A final object of the present invention is to provide a trailer hitch alignment system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an image of the imaging means and markers applied to the vehicle and trailer for capturing the marker locations for further processing.

FIG. 2 shows an example of the imaging means view at the rear of the towing vehicle during the coupling procedure.

FIG. 3 shows an example of the simplified marker plot of the towing vehicle ball mount and the coupler.

FIG. 4 shows a view of the imaging means attached to the rear of the towing vehicle.

FIG. 5 shows a view within the cab of the towing vehicle, wherein an embodiment of the viewer is shown for the operator to monitor the location of the hitching components while maneuvering the vehicle.

### DETAILED DESCRIPTION OF THE INVENTION

Reference is made herein to the attached drawings. Like reference numerals are used throughout the drawings to depict like or similar elements of the trailer hitch system. For the purposes of presenting a brief and clear description of the present invention, the preferred embodiment will be discussed as used for aligning the hitching elements of a towing vehicle with a trailer using a rear-mounted imaging system and markers disposed on the hitching elements for the operator to monitor while reversing the towing vehicle. The figures are intended for representative purposes only and should not be considered to be limiting in any respect.

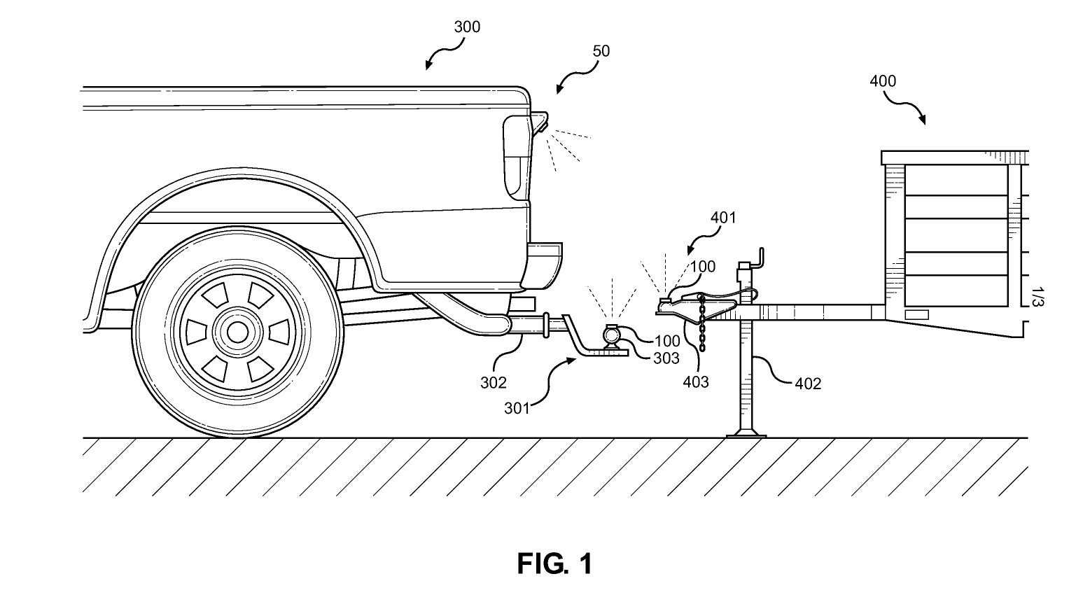

Referring now to FIG. 1, there is shown a side view of the trailer hitch system of the present invention in a working state, wherein a rear-mounted imaging means 50 is monitoring the proximity of the hitching components behind the towing vehicle 300 during the alignment and coupling process. The present system contemplates several embodiments of its system components for achieving a real-time view in a two-dimensional plane of the hitching components as a vehicle operator aligns the components prior to coupling the vehicle 300 to the trailer 400. In its basic form, the present invention contemplates a rear-mounted, downward facing imaging means 50, such as a digital camera or the like, and a reflective marker 100 deployable on the hitching components of the vehicle 301 and the trailer 401.

To couple the ball mount 303 towing vehicle hitching component 301 to the coupler 403 trailer hitching component 401, the two must be aligned and overlap one another. With heavier loads or larger trailers, the two components 303, 403 must be nearly perfectly overlapped, as adjustments to the trailer become difficult through manual input. Therefore, careful operation of the lead vehicle 300 and reversing the same into the correct position is critical to achieving a secure connection between the trailer 400 and vehicle 300.

To align the components, the imaging means 50 captures a view of the vehicle hitching components 301 and an area just rear of the vehicle. A two-dimensional plot is created for the user to simplify the positioning and to eliminate any perspective illusions. The two-dimensional plot is calculated by the system based on the image means, wherein a first and second marker 100 is further deployed on the ball mount 303 and trailer coupler 403 for locating the two components on the created plot.

Based on their location and the movement of the towing vehicle 300, the user can adjust his course while in reverse to align the two markers 100 and ensure the hitching components will achieve connection when exiting the vehicle. Ideally this positioning allows the operator to simply park the vehicle 300, exit the same, lower the support jack 402 of the trailer 400, and secure the trailer coupler 403 to the trailer hitch ball mount 303. Generally the ball mount 303 is supported by a hitch receiver 302 on the vehicle 300 and positioned at a distance from the rear of the vehicle for clearance. This clearance allows the imaging means 50 to capture the location of the marker 100 thereon and further the marker 100 of the coupler 403 once in the image means' field of view.

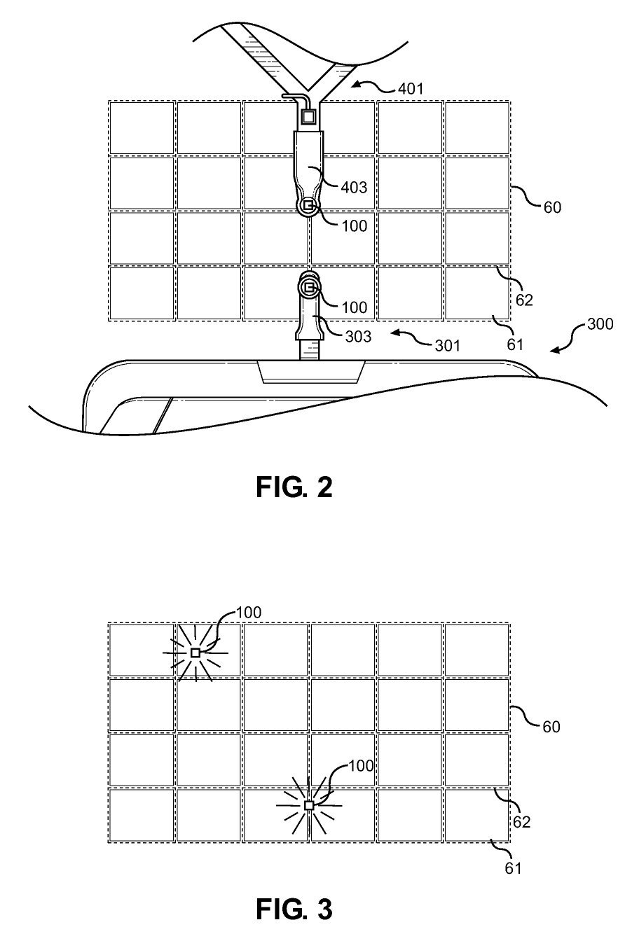

Referring now to FIG. 2, there is shown a view of the image means footage and its projection of the image onto a two-dimensional plot 60. The plot 60 is a projection that simplifies the view for the operator and eliminates the perspective view created by the positioning of the imaging means relative to the hitching components of the trailer 401 and towing vehicle 301. In operation, the image means further utilizes a camera and a light source, wherein the light source is adapted to be reflected by the markers 100 positioned on the trailer coupler 403 and the hitch ball mount 301.

The plot 60 includes gridlines 62 that are adapted to be positioned at a given distance away from the rear of the vehicle 300, whereby the operator can gauge the distance of the trailer coupler 403 and adjust his or her reversing speed. The base of the grid 61 is stationary with respect to the rear of the vehicle 300, as the imaging means is adapted to be securely mounted to the rear of the vehicle 300 during operation.

Referring now to FIG. 3, there is shown a view of the display given to the operator of the towing vehicle, wherein a simplified plot 60 is provided with only the markers 100 visualized. The first marker 100 at the base 61 of the plot is that marker placed on the towing vehicle hitching components, while the moving marker 100 is that of the stationary trailer as the vehicle reversed theretowards. Gridlines 62 allow the user to judge distances, and the simplified view eliminate distractions as the user attempts to maneuver the vehicle such that the two markers 100 are overlapping prior to exiting the vehicle to couple the hitching components.

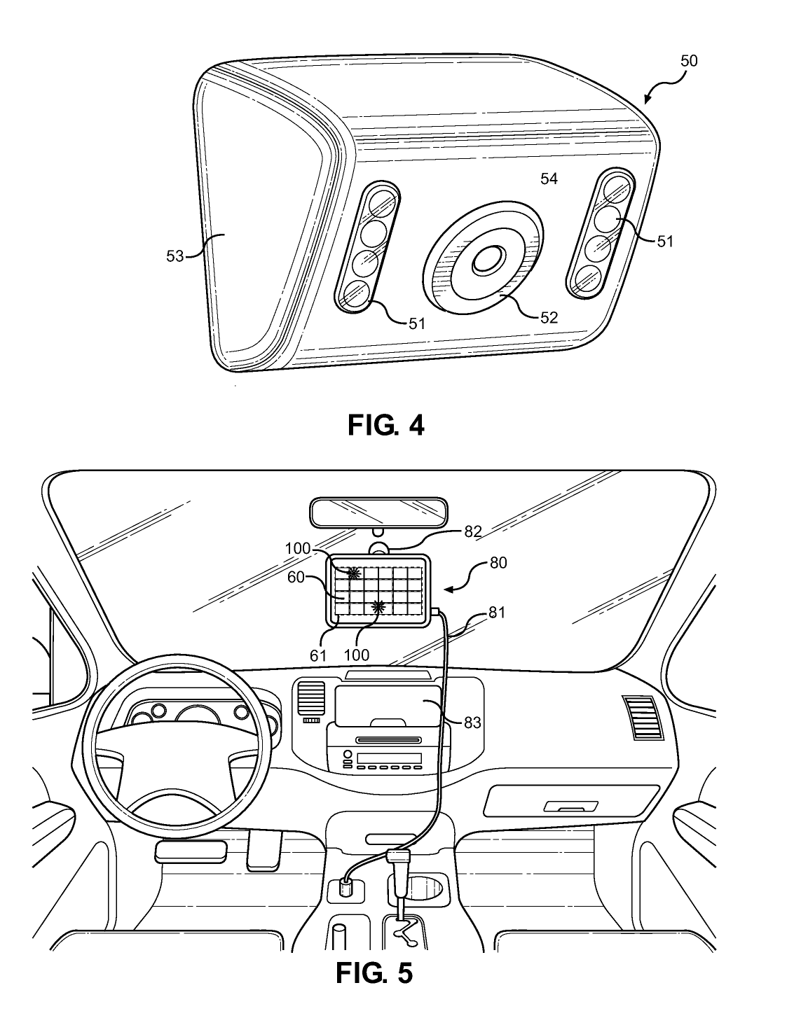

Referring now to FIG. 4, there is shown a view of an exemplary embodiment of the imaging means 50 of the present invention. It is contemplated that the image means 50 be positionable or permanently secured to the rear of a towing vehicle such that its image capture aperture is directed rearward and downward toward the trailer hitching components. Preferably, the imaging means comprises a digital video camera 52 having a lens, a digital video camera processor, and a power supply. The camera captures a live video at the rear of the towing vehicle for the system to process the view, project it onto a two dimensional plot and plot the markers attached to the hitching components.

The markers of the present invention comprise adhesable elements, preferably reflective tape or similarly reflective material. The imaging means 50 comprises a light source 51 thereon for use during the day and during low light conditions. The light source 51 preferably comprises a high intensity light such as Light Emitting Diodes (LEDS), which project light downward onto the markers for the imaging means to capture. The markers are thus easily recognizable in all light conditions and readily processed by the present system.

In one embodiment of the imaging means 50, the device comprises a housing having a downward facing surface 54 supporting the video lens 52 and light source 51, along with a backside surface 53 that is adapted to secure to a rear surface of the towing vehicle. This embodiment contemplates attachment of a device that can either be hardwired to a display within the vehicle or wirelessly connected thereto using a wireless protocol (e.g. short range Bluetooth or the like). The housing may further include an onboard power supply (e.g. a battery) or include a wired connection for power from the vehicle.

In a completely unwired configuration, the imaging means 50 housing is secured by way of adhesive backing or similar backside surface 53 attachment. Within the housing is a wireless antenna and a battery pack, whereby the device can wireless communicate to the vehicle cab display and power itself without a wired connection. It is contemplated that this embodiment would be temporarily affixed to the towing vehicle and can be utilized on different vehicles in a user's fleet as required, and then removed when not required.

In an alternate embodiment, the present system may be hardwired to the vehicle and further may be permanently secured thereto. It is contemplated that the housing of the imaging means can be permanently secured to the rear of the vehicle and the imaging means receive power and communicate to the cab display using a hardwired connection through the vehicle. This embodiment is contemplated for those that wish to retrofit a system to their vehicle or for vehicle manufacturers to provide a towing package that is original equipment for use with an integrated display in the vehicle or one that can be operably affixed within the vehicle cabin.

Referring now to FIG. 5, there is shown a view of the cab of the towing vehicle and one contemplated embodiment of the viewer 80 provided therein for the operator of the towing vehicle to monitor the positioning of the markers 100 placed on the hitching components. In this embodiment, an attachable view 80 is provided that is temporarily mounted in the vehicle cab. Other embodiments include viewers that are hardwired and integrated into the dash 83 of the vehicle cabin, and still others that operate using a personal smartphone device in communication with the rear-mounted imaging means and wireless system components. Power is provided to the operably attachable 82 viewer 80 by way of battery and cable 81 charging, as is typically found in the art of vehicle displays and navigation devices.

As the operator maneuvers the vehicle in reverse, he or she positions the vehicle in proximity to the trailer using the rearview mirror. Once the hitching components are within a few feet, the user can visualize the markers 100 placed thereon to maneuver the vehicle into a position wherein the hitching components are aligned. The grid 60, using the gridlines and lower grid line 61 as the rear of the vehicle, can steer the vehicle until the markers are overlaid upon one another.

The system components of the present invention include a processing means within the viewer or the imaging means to take the video feed from the imaging means and create the two-dimensional plot. Wired connections, or alternatively a wireless antenna communication means is necessary to allow the viewer to display the information captured by the video imaging means. The processing means receives the video image and processes the same, wherein a routine calculates the positioning of the markers and displays the same on the plot for the user to see in real-time.

Many individuals and business owners own a trailer that requires attaching to a towing vehicle for transport of cargo and supplies. A towing vehicle must be attached to a trailer with attention and care in order to avoid harming either the truck or the trailer. This requires alignment of the towing vehicle and the trailer so that they can be properly hitched. The process can be tedious, requiring a person to get out of the vehicle many times or enlist the help of a second individual. The act becomes burdensome and time-consuming.

The present invention describes a towing vehicle guidance system. The device comprises a first marker that is attached to the ball mount on a towing vehicle, a second marker that is attached to the trailer coupler, and a viewer in the cab of the vehicle for viewing the location of the markers. The viewer allows the user to track the position of the markers and thus the hitching components on a display, which alerts the driver as to the proximity of the ball mount with respect to the trailer coupler. As the first marker moves closer to the second marker, the display updates the information, thereby indicating that the vehicle is moving towards the trailer. This enables a person to connect a tow vehicle to a trailer without getting out of the vehicle to check their progress, reduces the amount of time needed to hitch a trailer to a truck, and eliminates the need to ask a second person to help line up the vehicle ball and trailer hitch.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A trailer hitch alignment system for a towing vehicle, comprising:
a digital imaging means adapted to be mounted to the rear of a towing vehicle and view an area behind said towing vehicle;
said digital imaging means having a light source;
said imaging means having a processing means, a lens, and a power supply;
a viewer comprising a display screen, a processing means, a power supply, and a communication means with said digital imaging means;
said viewer adapted to display a plot of the field of view of said imaging means;
a first and second reflective marker having an attachable surface, wherein said first marker is adapted to be positioned on the hitching components of said towing vehicle and said second is adapted to be positioned on the hitching components of a trailer.

2) The trailer hitch alignment system of claim 1, wherein:
said viewer comprises an operably affixable display within said towing vehicle cab;
said viewer further comprises a battery power supply and charging cable adapted to charge said battery power supply with vehicle power.

3) The trailer hitch alignment system of claim 1, wherein:
said viewer is permanently affixed within the dash of said towing vehicle cab;
said viewer further comprises a hardwired connection to said vehicle power supply, and said communication means of said with digital imaging means comprises a hardwired connection.

4) The trailer hitch alignment system of claim 1, wherein:
a digital imaging means further comprises a housing affixable to the rear of said towing vehicle;
said a digital imaging means further comprises a wireless antenna;
said communication means of said viewer with digital imaging means comprises a wireless connection.

5) The trailer hitch alignment system of claim 1, wherein said viewer further comprises a handheld smartphone device having a wireless antenna, processing means, and display.
